(19) United States
(12) Patent Application Publication
(10) Pub. No.: US 2015/0307640 A1
(43) Pub. Date: Oct. 29, 2015

(54) POLYBUTADIENE HAVING EPOXY GROUPS

(71) Applicant: EVONIK INDUSTRIES AG, Essen (DE)

(72) Inventors: Andreas BERLINEANU, Marl (DE); Niko HABERKORN, Dorsten (DE)

(21) Appl. No.: 14/410,326

(22) PCT Filed: Jun. 25, 2013
(86) PCT No.: PCT/EP2013/063222

§ 371 Date: Dec. 22, 2014

(30) Foreign Application Priority Data
Jun. 29, 2012 (EP) 12174420.5

(51) Int. Cl. C08F 136/06; C08L 47/00; C08L 63/00

(52) U.S. Cl. CPC C08F 136/06; C08L 63/00; C08L 47/00

(57) ABSTRACT

A polybutadiene with epoxy groups, where the following monomer units are contained in the polybutadiene:

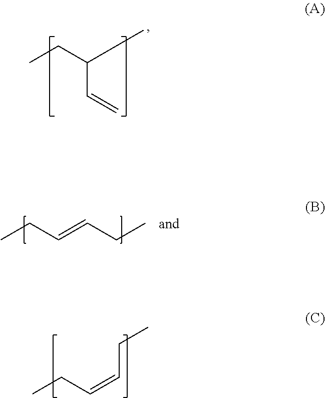

where the proportion of A, based on the entirety of 1,3-butadiene-derived monomer units present in the polybutadiene, is from 10 to 60 mol percent, and where the sum of the proportions of B and C, based on the entirety of the 1,3-butadiene-derived monomer units present in the polybutadiene is from 40 to 90 mol percent. The polybutadiene with epoxy groups is produced by polymerizing to form a polybutadiene with terminal hydroxyl groups, reacting with a monepoxy compound, and adding an alkali metal hydroxide, alkali metal hydrogencarbonate or alkali metal carbonate to the reaction mixture. A composition containing the polybutadiene with epoxy groups is also disclosed.

The invention relates to a polybutadiene having epoxy groups, where the polybutadiene comprises the following 1,3-butadiene-derived monomer units:

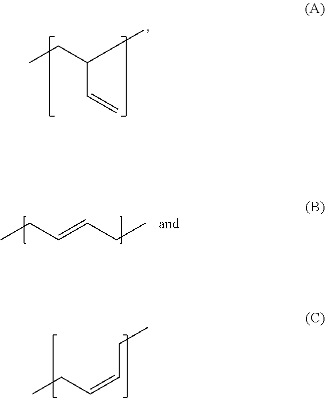

where the proportion of A in the entirety of the 1,3-butadiene-derived monomer units present in the polybutadiene is from 10 to 60 mol per cent, the sum of the proportions of B and C in the entirety of the 1,3-butadiene-derived monomer units present in the polybutadiene is from 40 to 90 mol per cent, to a process for the production of the polybutadiene of the invention, and also to a composition comprising the polybutadiene having epoxy groups.

Polybutadienes are a class of organic compounds of great industrial importance, and are produced by polymerization of 1,3-butadiene, which is obtainable in large quantities from the cracking of petroleum. They are starting materials of considerable interest and importance for chemical syntheses on both laboratory and industrial scale.

The polymerization of 1,3-butadiene to give polybutadiene can easily be carried out by way of processes described in the prior art which comprise anionic polymerization. However, in many applications the resultant butadienes cannot be used directly but instead first require modification.

This modification can in particular be epoxidation by means of reagents such as epichlorohydrin. Epoxide groups can be utilized for a wide variety of other reactions, in particular with anhydrides or amines. The resultant polybutadiene having epoxy groups can therefore be reacted with reagents such as diamines to form a robust plastic.

Shell Oil Company, Research Disclosure, Vol. 416, 12, 1998, page 1594, describes the preparation of butadiene polymers having epoxy groups. The polydienediols were obtained by way of anionic polymerization. Mention is made of the poor compatibility of the products and the low functionality of these: 1.1 and, respectively, 1.6 and 2. The reaction of the glycidic ethers with EPICURE 3140 polyamide is described, for improving compatibility.

The invention in SU195104 (Lebedev rubber institute) describes the synthesis of an anionic polybutadiene polymer, giving a “living polymer” with metal atoms of group I-III, and treatment of these with epichlorohydrin, acids and bases. Prior to the reaction with epichlorohydrin, the “living polymer” is not isolated and freed from butadiene oligomers. The products are reacted with maleic anhydride and phthalic anhydride.

The processes described in the prior art for the production of polybutadiene having epoxy groups have the disadvantage, however, that the polybutadiene has low processability, high viscosities and high glass transition temperatures. Furthermore, the products in the processes described in the prior art for the production of polybutadiene having epoxy groups have poor compatibility with other components of coating compositions, in particular epoxy resins.

In the light of this, the object underlying the invention consists in providing a polybutadiene having epoxy groups and a process for the production thereof, which has more advantageous processing properties, in particular minimized viscosity and/or glass transition temperature.

Another object underlying the invention is to provide a polybutadiene having epoxy groups which has maximized compatibility with other components of coating compositions, in particular epoxy resins.

These and other objects are achieved by the subject matter of the present application and particularly also by the subject matter of the accompanying independent claims, with embodiments arising from the dependent claims.

A first aspect of the problem underlying the object is solved through a polybutadiene having epoxy groups, where the polybutadiene comprises the following 1,3-butadiene-derived monomer units:

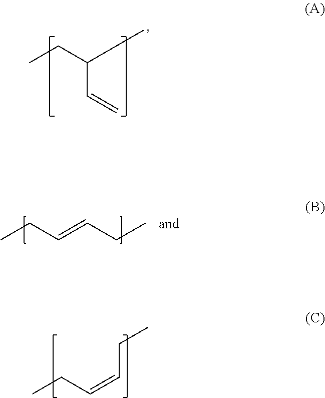

where the proportion of A in the entirety of the 1,3-butadiene-derived monomer units present in the polybutadiene is from 10 to 60 mol per cent,
and where the sum of the proportions of B and C in the entirety of the 1,3-butadiene-derived monomer units present in the polybutadiene is from 40 to 90 mol per cent.

In a first embodiment of the first aspect, the problem is solved through a polybutadiene having epoxy groups, where the proportion of A, B and C in the entirety of the 1,3-butadiene-derived monomer units present in the polybutadiene is in each case and mutually independently at least 10%.

In a second embodiment of the first aspect, which is also an embodiment of the first embodiment, the problem is solved through a polybutadiene having epoxy groups, where the proportion of A in the entirety of the 1,3-butadiene-derived monomer units present in the polybutadiene is from 15 to 30 mol per cent, the proportion of B in the entirety of the 1,3-butadiene-derived monomer units present in the polybutadiene is from 50 to 70 mol per cent, and the proportion of C in the entirety of the 1,3-butadiene-derived monomer units present in the polybutadiene is from 15 to 30 mol per cent.

In a third embodiment of the first aspect, which is also an embodiment of the first to second embodiment, the problem is solved through a polybutadiene having epoxy groups, where the epoxy groups have the formula (I)

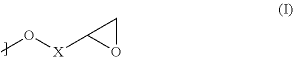

and X represents a linear or branched alkylene group, preferably a linear alkylene group of the formula —(CH₂)ₓ—, where x is from 1 to 4, more preferably 1.

In a fourth embodiment of the first aspect, which is also an embodiment of the first to third embodiment, the problem is solved through a polybutadiene having epoxy groups, where the polybutadiene has from 1.5 to 3 epoxy groups, preferably from 1.75 to 2.5.

In a second aspect, the problem underlying the invention is solved through a process for the production of a polybutadiene having epoxy groups, comprising the following steps:
a) provision of a polybutadiene produced by means of free-radical polymerization and having hydroxy groups,
b) reaction of the polybutadiene having hydroxy groups from step a) with a monoepoxy compound in a reaction mixture,
   where the molar ratio between terminal hydroxy groups and the monoepoxy compound is from 10:1 to 1:10,
   where the temperature is from 0 to 150° C.,
   and where the reaction time is from 0.5 to 24 hours.
c) addition of an alkali metal hydroxide, alkali metal hydrogencarbonate or alkali metal carbonate to the reaction mixture from step b),
   where the polybutadiene having terminal hydroxy groups comprises the 1,3-butadiene-derived monomer units

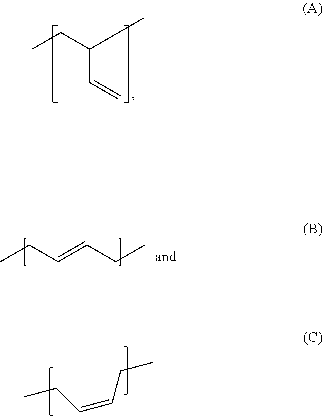

where the proportion of A in the entirety of the 1,3-butadiene-derived monomer units present in the polybutadiene is from 10 to 60 mol per cent,
and where the sum of the proportions of B and C in the entirety of the 1,3-butadiene-derived monomer units present in the polybutadiene is from 40 to 90 mol per cent,
where the proportion of A, B and C in the entirety of the 1,3-butadiene-derived monomer units present in the polybutadiene is respectively and mutually independently preferably at least 10%,
   where more preferably the proportion of A in the entirety of the 1,3-butadiene-derived monomer units present in the polybutadiene is from 15 to 30 mol per cent, the proportion of B in the entirety of the 1,3-butadiene-derived monomer units present in the polybutadiene is from 50 to 70 mol per cent and the proportion of C in the entirety of the 1,3-butadiene-derived monomer units present in the polybutadiene is from 15 to 30 mol per cent.

In a first embodiment of the second aspect, the problem is solved through a process where the monoepoxy compound is selected from the group which comprises epihalohydrins, preferably epichlorohydrin, β-methylepichlorohydrin or epibromohydrin, and alkylene oxides, preferably ethylene oxide, propylene 1,2-oxide or butylene 1,2-oxide.

In a second embodiment of the second aspect, which is also an embodiment of the first embodiment, the problem is solved through a process where the molar ratio between the monoepoxy compound and terminal hydroxy groups in the reaction mixture in step b) is from 0.5 to 2, preferably 0.9 to 1.2.

In a third embodiment of the second aspect, which is also an embodiment of the first to second embodiment, the problem is solved through a process where step b) proceeds in the presence of a solvent, where the solvent is preferably selected from the group consisting of the room-temperature-liquid aliphatics, aromatics, esters and ethers.

In a fourth embodiment of the second aspect, which is also an embodiment of the first to third embodiment, the problem is solved through a process where step b) proceeds in the presence of at least one metal salt or semimetal salt which comprises at least one metal cation or semimetal cation, preferably selected from the group comprising boron, aluminium, zinc and tin and at least one anion selected from the group consisting of F⁻, Cl⁻, BF₄⁻, PF₆⁻, AsF₆⁻, SbF₆⁻, ClO₄⁻, IO₄⁻ and NO₃⁻.

In a fifth embodiment of the second aspect, which is also an embodiment of the first to fourth embodiment, the problem is solved through a process where, in step c), from 0.7 to 1.4 mol of alkali metal hydroxide, alkali metal hydrogencarbonate or alkali metal carbonate are added per mole of terminal hydroxy groups in step a).

In a sixth embodiment of the second aspect, which is also an embodiment of the first to fifth embodiment, the problem is solved through a process further comprising distillative removal of excess monoepoxy compound after step b) and before step c).

In a seventh embodiment of the second aspect, which is an embodiment of the third to sixth embodiment, the problem is solved through a process where step b) is carried out in the presence of a solvent and this is removed from the reaction mixture before, during or after step c), preferably after step c).

In an eighth embodiment of the second aspect, which is an embodiment of the third to seventh embodiment, the problem is solved through a process where step b) proceeds in the presence of inert gas.

In a third aspect, the problem underlying the invention is solved through a composition comprising the polybutadiene having epoxy groups according to the first aspect or to an embodiment of the first aspect, or through the polybutadiene which has epoxy groups and has been produced by the process according to the second aspect or to an embodiment of the second aspect, and also at least one hardener, and optionally also at least one epoxy resin.

In a fourth aspect, the problem underlying the invention is solved through a binder in adhesive compositions, sealing compositions and acoustic compositions for automobile applications, casting-resin formulations for electrical insulation, sealing compositions for construction materials, or for the impregnation or adhesive bonding of glass- and carbon-fibre textiles comprising the polybutadiene having terminal epoxy groups according to the first aspect or to an embodiment of the first aspect, or the polybutadiene which has terminal epoxy groups and has been produced by the process according to the second aspect or to an embodiment of the second aspect, and at least one hardener, and optionally also at least one epoxy resin.

In a fifth aspect, the problem underlying the invention is solved through a use of the polybutadiene having terminal epoxy groups according to the first aspect or to an embodiment of the first aspect, or of the polybutadiene which has terminal epoxy groups and which has been produced by the process according to the second aspect or to an embodiment of the second aspect, or of the composition according to the third aspect as binder in adhesive compositions, sealing compositions and acoustic compositions for automobile applications, casting-resin formulations for electrical insulation, in sealing compositions for construction materials, for the impregnation or adhesive bonding of glass- and carbon-fibre textiles.

In a fifth aspect, the problem underlying the invention is solved through a process comprising the step of hardening of the composition according to the third aspect.

The present invention is based on the surprising discovery that polybutadiene having epoxy groups and produced by starting from polybutadiene obtained by means of free-radical polymerization has low viscosity and glass transition temperature. Without any intention of adopting any particular theory, the inventors of the present invention suppose that free-radical polymerization, unlike anionic polymerization of polybutadiene, gives a polybutadiene having high content of 1,2-vinyl as monomer unit in the polymer, and that this monomer gives rise to the properties mentioned.

The present invention relates to polybutadiene having hydroxy groups and produced by free-radical polymerization of 1,3-butadiene and, produced therefrom, polybutadiene having epoxy groups, in each case comprising the 1,3-butadiene-derived monomer units A), B) and C) present in the polybutadiene, where a square bracket in the formula representation selected in this application for the 1,3-butadiene-derived monomer units A), B) and C) present in the polybutadiene indicates that the bond at the respective square bracket is not terminated by way of example by a methyl group, and that, instead, the corresponding monomer unit is bonded by way of this bond to another monomer unit or another functional group, in particular a hydroxy group or epoxy group. The arrangement here can have the monomer units A), B) and C) in any desired sequence in the polymer. A random arrangement is preferred.

In a preferred embodiment, there can also be other monomer units present alongside the 1,3-butadiene-derived monomer units A), B) and C) present in the polybutadiene, in particular monomer units not derived from 1,3-butadiene. In a most preferred embodiment, however, the entirety of the 1,3 butadiene-derived monomer units A), B) and C) present in the polybutadiene represents a proportion of at least 80 mol per cent, preferably 90 mol per cent, more preferably 95 mol per cent, most preferably 100 mol per cent, of the entirety of the monomer units incorporated in the polymer, comprising the 1,3-butadiene-derived units and other units.

The polybutadiene of the invention having epoxy groups or the polybutadiene produced by the process of the invention and having epoxy groups is almost colourless and has low viscosity. Viscosity is preferably determined at 20° C. with a rotary viscometer from Haake.

In a preferred embodiment, the polybutadiene of the invention having epoxy groups or the polybutadiene produced by the process of the invention and having epoxy groups has an average functionality of from 1.5 to 3, preferably from 1.75 to 2.5. In a more preferred embodiment, this means that a polybutadiene molecule, irrespective of its length, has on average from 1.5 to 3 epoxy groups, preferably from 1.75 to 2.5.

The process of the invention requires, as step a), the provision of a polybutadiene which has been produced by means of free-radical polymerization and which has hydroxy groups. A polybutadiene of this type having hydroxy groups can by way of example be produced by polymerization of 1,3-butadiene in the presence of hydrogen peroxide, water and an organic solvent, as described in EP12169794.0. In a preferred embodiment, the term “polybutadiene” as used herein means a product obtained by polymerization of monomer units having in each case at least two conjugated double bonds, where the proportion of monomer units that are 1,3-butadiene is, in order of increasing preference, at least 80, 85, 90, 95, 98, 99 or 99.9%.

In step b) of the process of the invention, the polybutadiene having hydroxy groups is reacted with a monoepoxy compound in the presence of inert gas. A particularly suitable monoepoxy compound is an epihalohydrin, preferably selected from the group which comprises epichlorohydrin, beta-methylepichlorohydrin or epibromohydrin, or else selected from an alkylene oxide, preferably selected from the group which comprises ethylene oxide, propylene 1,2-oxide and butylene-1,2 oxide. It is preferable to use an amount of from 0.5 to 2 mol of epichlorohydrin per equivalent of a polybutadiene-bonded hydroxy group. It is particularly preferable to use an amount of 0.9 to 1.2 mol of epichlorohydrin per equivalent of a polybutadiene-bonded hydroxy group.

In a preferred embodiment, step b) proceeds in a solvent. In a preferred embodiment, the solvent is a room-temperature-liquid aliphatic, for example hexane, heptane, octane, cyclohexane, a room-temperature-(25° C.)-liquid aromatic, for example benzene, toluene, a room-temperature-liquid ester, for example ethyl acetate, butyl acetate, or a room-temperature-liquid ether, for example diethyl ether and diisopropyl ether, dioxane and tetrahydrofuran. The nature and amount of the solvent depends on the polybutadiene having hydroxy groups used and on the amount of the monoepoxy compound. Solvent mixtures of the solvents mentioned are possible in any desired quantitative ratios. The proportion of the entirety of polybutadiene having hydroxy groups and monoepoxy compound in the reaction mixture can in each case be from 5 to 80 per cent by weight.

The reaction is carried out in the presence of inert gas at reduced or elevated pressure. In a preferred embodiment, the expression “inert gas” as used herein means a gas or gas mixture, the entirety of which is inert. It is preferable that the inert gas is nitrogen, noble gases or mixtures thereof.

It is preferable that the duration of step b) is from 0.5 to 24 hours.

The temperature in step b) is from 0 to 150° C., preferably from 0 to 70° C.

Either the polybutadiene having hydroxy groups or the monoepoxy compound can be used as initial charge when the reaction in step b) is started. As an alternative, it is also possible to use both compounds together as initial charge. The reaction mixture is then brought to the reaction temperature by heating.

It is preferable that step b) proceeds in the presence of a metal salt or semimetal salt, as catalyst. This is at least one metal of the main or transition groups of the Periodic Table, preferably selected from the group comprising boron, aluminium, zinc and tin, and at least one anion from the group comprising F⁻, Cl⁻, BF₄⁻, PF₆⁻, AsF₆⁻, SbF₆⁻, ClO₄⁻, IO₄⁻, and NO₃⁻. The amount used of the catalyst is preferably from 0.001 to 0.5 mol of the metal salt per equivalent of polybutadiene-bonded hydroxy group. The reactants and the catalyst can be used as initial charge and then reacted. It is preferable that the metal salt catalyst is used with the polybutadiene having hydroxy groups as initial charge and that the monoepoxy compound, preferably epihalohydrin, is then added.

It is preferable that excess monoepoxy compound is removed by distillation after step b), and it is preferable here that the solvent is added only after the said removal of the excess monoepoxy compound.

In step c) dehydrohalogenation is achieved through addition of at least one alkali metal hydroxide as base to the reaction mixture from step b), in order to form the alkali metal halide. In a preferred embodiment, the amount of the alkali metal hydroxide added is from 0.7 to 1.4 mol per equivalent of polybutadiene-bonded hydroxy group. The temperature in step c) should be from 0 to 80° C.

The polybutadiene of the invention having epoxy groups can be used according to the invention in a composition comprising the polybutadiene having epoxy groups and also at least one hardener, and optionally in addition at least one epoxy resin.

In a preferred embodiment, the expression “epoxy resin” as used herein means a prepolymer which has two or more epoxy groups per molecule. The reaction of the said resins with a large number of crosslinking agents, also termed hardeners, leads to crosslinked polymers. These polymers can be thermosets, and can be used in sectors such as civil engineering (construction), particularly in industrial floors, sealing systems and concrete-renovation products, composites (fibre-composite materials), potting compositions, coating materials and adhesives. An overview of the resins and hardeners, and also use of these in the civil engineering sector, inclusive of their properties, is found in H. Schuhmann, “Handbuch Betonschutz durch Beschichtungen” [Handbook of concrete protection by coatings], Expert Verlag 1992, p. 396-428. The use of the resins and hardeners for the composites sector is described in P. K. Mallick, “Fiber-Reinforced Composites, Materials, Manufacturing, and Design”, CRC Press, p. 60-76. Epoxy resin used according to the invention can be any of the epoxy resins that can be cured by amines. Among the epoxy resins are by way of example polyepoxides based on bisphenol A diglycidyl ether, bisphenol F diglycidyl ether or cycloaliphatic types such as 3,4-epoxycyclohexylepoxyethane or 3,4-epoxycyclohexylmethyl 3,4-epoxycyclohexanecarboxylate. In the composition of the invention it is preferable to use at least one epoxy resin selected from the group which comprises epoxy resins based on bisphenol A diglycidyl ether, epoxy resins based on bisphenol F diglycidyl ether and cycloaliphatic types such as 3,4-epoxycyclohexylepoxyethane or 3,4-epoxycyclohexylmethyl 3,4-epoxycyclohexanecarboxylate, particular preference being given here to bisphenol A-based epoxy resins and to bisphenol F-based epoxy resins. Compounds of this type are obtainable commercially.

Hardeners used can comprise any of the hardeners described in the prior art for curable compositions comprising at least one epoxy compound, in particular amine-containing hardeners which have at least two or more primary and/or secondary amino groups, e.g. diethylenetriamine, triethylenetetramine, methylenedianiline, bis(aminocyclohexyl)methane, 3,3′-dimethyl-4,4′-diaminodicyclohexylmethane, tricyclododecanediamine, norbornanediamine, N-aminoethylpiperazine, isophoronediamine, m-phenylenebis(methylamine), 1,3- and/or 1,4-bis(aminomethyl)cyclohexane, trimethylhexamethylenediamine, polyoxyalkyleneamines, polyaminoamides, and reaction products of amines with acrylonitrile and Mannich bases, and also a polyamine selected from the group comprising isophoronediamine, diethylenetriamine, trimethylhexamethylenediamine, m-phenylenebis(methylamine), 1,3-bis(aminomethyl)-cyclohexane, methylenebis(4-aminocyclohexane), 3,3′-dimethyl-4,4′-diaminodicyclohexylmethane, N-aminoethylpiperazine, polyoxyalkyleneamines, polyaminoamides, reaction products of amines with acrylonitrile and Mannich bases.

The composition of the invention can comprise not only the polybutadiene having epoxy groups, the hardener, and optionally the epoxy resin, but also other compounds, in particular a solvent, such as xylene or isopropanol, at least one reaction accelerator, preferably from the group of organic acids or tertiary amines, e.g. salicylic acid, aminoethylpiperazine, tris-(N,N-dimethylaminomethyl)phenol, and also pigments, fillers and/or additives, a reactive diluent preferably selected from the group of mono-, bi- or polyfunctional, room-temperature-liquid epoxy compounds, e.g. butyl glycidic ether, 1,6-hexane glycidic ether and 1,4-butane diglycidic ether, neopentyl diglycidic ether, phenyl glycidic ether, glycidic ether of Versatic acid, C12-C14 glycidic ether, C13-C15 glycidic ether, p-tert-butylphenyl glycidic ether, neopentyl glycol diglycidic ether, polybutylene diglycidic ether, glycerol triglycidic ether, pentaerythro polyglycidic ether, trimethylolpropane triglycidic ether and cresyl glycidic ether, and finally a modifier such as benzyl alcohol, coumarone resin or reactive rubbers.

The present invention is further illustrated by the following figures and non-limiting examples, from which further features, embodiments, aspects and advantages of the present invention may be taken.

### EXAMPLES

The following polybutadienes having hydroxy groups: Polyvest EP HT and Poly bd R-20LM (Cray Valley) and properties of these are compared representatively with a reference product from anionic polymerization (NISSO-PB G1000, Nippon Soda).

Polyvest EP HT with the specifications listed below is synthesized according to the synthesis instructions described in the Patent EP12169794.0.

Both products, Polyvest EP HT and Poly bd R-20LM, were used for the production of the polybutadienes having epoxy groups.

### Selection of the Polybutadienes Having Hydroxy Groups

| | POLYVEST | Poly bd | NISSO-PB |
|---|---|---|---|
| | EP HT | R-20LM | G-1000 |
| Viscosity at 23° C. [Pa s] | 7.61 | 2.53 | 109.53 |
| Steric distribution | | | |
| 1,2-vinyl [%] | 22 | 22 | 89 |
| 1,4-trans [%] | 58 | 58 | 11 |
| 1,4-cis [%] | 20 | 20 | — |
| Molar mass Mn [g/mol] | 3397 | 1812 | 2077 |
| OH number [mg KOH/g] | 48 | 96 | 77.7 |
| Tg value [° C.] | −80 | −75 | −26 |

### Example 1

116.8 g (0.1 mol of OH equivalent) of Polyvest EP HT dissolved in 83.2 g of toluene are used as initial charge together with 0.19 g (0.001 mol) of SnCl2 in a sulphonation flask provided with thermometer, stirrer, reflux condenser, nitrogen blanketing and dropping funnel. 10.18 g (0.11 mol) of epichlorohydrin are added at room temperature, with stirring, to this mixture. The reaction mixture is heated for 5 hours to an internal temperature of 100° C. The mixture is cooled to 50° C. and then within 30 minutes 1.6 g (0.02 mol) of 50% aqueous NaOH solution and 3.6 g (0.09 mol) of pulverized NaOH, in portions, are added. Stirring of this mixture is continued for 1 hour at 50° C. The reaction mixture is filtered. The organic phase is dried over MgSO4 and filtered and isolated in vacuo from the solvent. 112 g (91.5% of theory) of the almost colourless polybutadiene glycidyl ether with an equivalent weight of 1840 are isolated. The viscosity of the product, determined with a rotary viscometer, is 14 Pa s at 20° C. The Tg value determined is −78° C. The microstructure of the polybutadiene used, having hydroxy groups, is retained (22% of 1,2-vinyl, 20% of 1,4-cis, 58% of 1,4-trans).

### Example 2

58.4 g (0.1 mol of OH equivalent) of Poly bd R-20LM dissolved in 41.6 g of toluene are used as initial charge together with 0.19 g (0.001 mol) of SnCl2 in a sulphonation flask provided with thermometer, stirrer, reflux condenser, nitrogen blanketing and dropping funnel. 10.18 g (0.11 mol) of epichlorohydrin are added at room temperature, with stirring, to this mixture. The reaction mixture is heated for 5 hours to an internal temperature of 100° C. The mixture is cooled to 50° C. and then within 30 minutes 1.6 g (0.02 mol) of 50% aqueous NaOH solution and 3.6 g (0.09 mol) of pulverized NaOH, in portions, are added. Stirring of this mixture is continued for 1 hour at 50° C. The reaction mixture is filtered. The organic phase is dried over MgSO4, again filtered, and isolated in vacuo from the solvent. 56.3 g (87.9% of theory) of the almost colourless polybutadiene glycidyl ether with an equivalent weight of 1010 are isolated. The viscosity of the product, determined with a rotary viscometer, is 4.2 Pa s at 20° C. The Tg value determined is −71° C. The microstructure of the polybutadiene used, having hydroxy groups, is retained (22% of 1,2-vinyl, 20% of 1,4-cis, 58% of 1,4-trans).

### Example 3

58.4 g (0.1 mol of OH equivalent) of Poly bd R-20LM dissolved in 41.6 g of toluene are used as initial charge together with 0.19 g (0.001 mol) of SnCl2 in a sulphonation flask provided with thermometer, stirrer, reflux condenser, nitrogen blanketing and dropping funnel. 10.18 g (0.11 mol) of epichlorohydrin are added at room temperature, with stirring, to this mixture. The reaction mixture is heated for 5 hours to an internal temperature of 100° C. The mixture is cooled to 50° C. and then within 30 minutes 1.6 g (0.02 mol) of 50% aqueous NaOH solution and 3.6 g (0.09 mol) of pulverized NaOH, in portions, are added. Stirring of this mixture is continued for 1 hour at 50° C., and 50 g of toluene are admixed. Water is removed from the reaction mixture by azeotropic distillation. The reaction mixture is filtered through MgSO4 and freed from the solvent in vacuo. 58.9 g (92.0% of theory) of the almost colourless polybutadiene glycidyl ether with an equivalent weight of 1005 were isolated. The viscosity of the product, determined with a rotary viscometer, is 4 Pa s at 20° C. The Tg value determined is −71° C. The microstructure of the polybutadiene used, having hydroxy groups, is retained (22% of 1,2-vinyl, 20% of 1,4-cis, 58% of 1,4-trans).

1. A polybutadiene comprising epoxy groups, wherein the polybutadiene comprises the following 1,3-butadiene-derived monomer units: 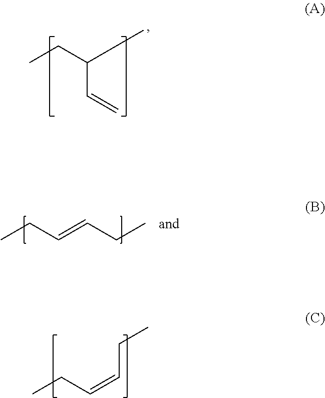
where the proportion of A in the entirety of the 1,3-butadiene-derived monomer units present in the polybutadiene is from 10 to 60 mol percent,
and the sum of the proportions of B and C in the entirety of the 1,3-butadiene-derived monomer units present in the polybutadiene is from 40 to 90 mol percent,
and wherein the epoxy groups have the formula 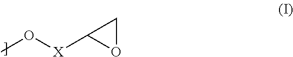
where X represents a linear or branched alkylene group.

2. The polybutadiene according to claim 1, wherein the proportion of A, B and C in the entirety of the 1,3-butadiene-derived monomer units present in the polybutadiene is in each case and mutually independently at least 10%.

3. The polybutadiene according to claim 1, wherein the proportion of A in the entirety of the 1,3-butadiene-derived monomer units present in the polybutadiene is from 15 to 30 mol percent, the proportion of B in the entirety of the 1,3-butadiene-derived monomer units present in the polybutadiene is from 50 to 70 mol percent, and the proportion of C in the entirety of the 1,3-butadiene-derived monomer units present in the polybutadiene is from 15 to 30 mol percent.

4. The polybutadiene according to claim 1, wherein the polybutadiene comprises, irrespective of its length, an average of 1.5 to 3 epoxy groups.

5. A process for the production of a polybutadiene comprising epoxy groups, comprising:
a) reacting a polybutadiene produced by free radical polymerization and comprising terminal hydroxy groups with a monoepoxy compound in a reaction mixture,
where the molar mass ratio between terminal hydroxy groups and the monoepoxy compound is from 10:1 to 1:10,
where the temperature is from 0 to 150° C.,
and where the reaction time is from 0.5 to 24 hours,
b) adding an alkali metal hydroxide, alkali metal hydrogencarbonate or alkali metal carbonate to the reaction mixture from a),
wherein the polybutadiene comprising terminal hydroxy groups comprises the following monomer units: 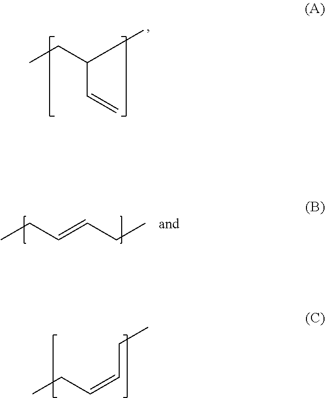
where the proportion of A in the entirety of the 1,3-butadiene-derived monomer units present in the polybutadiene comprising terminal hydroxy groups is from 10 to 60 mol percent,
the sum of the proportions of B and C in the entirety of the 1,3-butadiene-derived monomer units present in the polybutadiene comprising terminal hydroxy groups is from 40 to 90 mol percent,
and the proportion of A, B and C in the entirety of the 1,3-butadiene-derived monomer units present in the polybutadiene comprising terminal hydroxy groups is respectively and mutually independently at least 10%.

6. The process according to claim 5, wherein the monoepoxy compound is at least one selected from the group consisting of an epihalohydrin and an alkylene oxide.

7. The process according to claim 5, wherein the molar mass ratio between the monoepoxy compound and terminal hydroxy groups in the reaction mixture in a) is from 0.5 to 2.

8. The process according to claim 5, wherein a) proceeds in the presence of a solvent, wherein the solvent is at least one selected from the group consisting of a room-temperature-liquid aliphatic, aromatic, ester and ether.

9. The process according to claim 5, wherein a) proceeds in the presence of a metal salt or semimetal salt which comprises at least one metal cation or semimetal cation selected from the group consisting of boron, aluminium, zinc and tin and at least one anion selected from the group consisting of F⁻, Cl⁻, BF₄⁻, PF₆⁻, AsF₆⁻, SbF₆⁻, ClO₄⁻, IO₄⁻ and NO₃⁻.

10. The process according to claim 5, wherein, in b), 0.7 to 1.4 mol of alkali metal hydroxide, alkali metal hydrogencarbonate or alkali metal carbonate are added per mole of terminal hydroxy groups in a).

11. The process according to claim 5, further comprising distillative removal of excess monoepoxy compound after a) and before b).

12. The process according to claim 8, wherein a) is carried out in the presence of the solvent, which is removed from the reaction mixture before, during or after b).

13. The process according to claim 8, wherein a) proceeds in the presence of inert gas.

14. A composition comprising the polybutadiene comprising epoxy groups according to claim 1, a hardener, and optionally an epoxy resin.

15. A binder in an adhesive composition, a sealing composition and an acoustic composition, a casting-resin formulation, and a sealing composition comprising the polybutadiene comprising terminal epoxy groups according to claim 1, a hardener, and optionally an epoxy resin.

16. (canceled)

17. A process comprising hardening the composition according to claim 14.
